(19) United States
(12) Patent Application Publication
(10) Pub. No.: US 2007/0233783 A1
(43) Pub. Date: Oct. 4, 2007

(54) Communication device

(75) Inventor: Yoshifumi Tanimoto, Fushimi-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/730,432

(22) Filed: Apr. 2, 2007

(30) Foreign Application Priority Data
Apr. 3, 2006 (JP) 2006-101578

(51) Int. Cl. G06F 15/16

(52) U.S. Cl. 709/203

(57) ABSTRACT

Composed video data is transmitted from a communication unit to a recipient communication device. Management information in which a position of an image composed in the video and corresponding file data are associated is stored in a storage unit. The recipient communication device displays the received composed video on a display unit. When a user designates the image composed in the video from a designating unit, a data acquiring unit transmits a file acquiring request command including position information of the designated image in the video to the transmitter communication device. The transmitter communication device extracts the position information from the file acquiring request command, and extracts file data to be transmitted from the management information. The transmitter communication device transfers the file data to the recipient communication device through a communication connection not used for a video.

### BACKGROUND OF THE INVENTION

1. Field of the Invention

The present invention relates to a communication device which carries out video communication.

2. Description of the Related Art

Recently, accompanying development of communication technology and propagation of broadband networks, video communication such as a teleconference system and a television-phone system are carried out widely. For example, in a teleconference system, a video taken by a camera or the like is transmitted between users in real-time. Accordingly, users at different locations can continue their discussions while looking at a circumstance of a conference, for example, a state of another party. In such a teleconference system, data of a reference used in the conference is transferred as a file in advance, or a photograph of a reference is taken by a camera and transmitted as a video (moving image) or an image (still image). A known teleconference system transmits files by multiplexing the files.

However, even when there is a party who does not need to receive file data of a reference or the like, the file data is transferred collectively to all parties imposing a load on a network. When a user wishes just to have another party browse a content, or when the user wishes to distribute data to another party, the conventional system fails to transfer data according to various purposes.

### SUMMARY OF THE INVENTION

In order to overcome the problems described above, preferred embodiments of the present invention provide a communication device which can flexibly handle transferring of file data while transferring a video.

According to an aspect of the present invention, a communication device which transmits a video (hereinafter referred to as a “transmitter communication device”) includes a communication unit, a composing unit, a storage unit, and a data transferring unit. The communication unit carries out communication through a network. The composing unit transmits a composed video, which has been formed by composing an image of file data and a video, from the communication unit. The storage unit associates and stores a position of the image of the file data included in the composed video with the file data. The data transferring unit specifies data from the storage unit according to position information received by the communication unit, and transmits the specified data from the communication unit. Alternatively, the communication device includes a communication unit, a composing unit, and a data transferring unit. The communication unit carries out communication through a network. The composing unit transmits a composed video, which has been formed by composing an image of file data and a video, from the communication unit. The data transferring unit transmits management information, in which a position of the image of the file data included in the composed video is associated with the file data, from the communication unit. In addition, the data transferring unit transmits the file data from the communication unit according to a data transferring request received by the communication unit.

According to an aspect of the present invention, a communication device which receives a video (hereinafter referred to as a “recipient communication device”) includes a communication unit, a display unit, a designating unit, and a data acquiring unit. The communication unit carries out communication through a network. The display unit displays a composed image, which has been formed by composing an image of file data and a video received by the communication unit. The designating unit is operated by a user for designating a position in the displayed composed image. The data acquiring unit transmits from the communication unit, information of the position in the composed image designated by the user from the designating unit. The data acquiring unit receives corresponding data by the communication unit. Alternatively, the communication device includes a communication unit, a display unit, a designating unit, and a data acquiring unit. The communication unit carries out communication through a network. The display unit displays a composed image, which has been formed by composing an image of file data and a video received by the communication unit. The designating unit is operated by a user for designating a position in the displayed composed image. According to management information in which the position of the image of the data in the composed image received by the communication unit is associated with the file data, the data acquiring unit specifies the file data from information of the position in the composed image designated by the user from the designating unit. Then, the data acquiring unit transmits a request from the communication unit to a transmitter to request transferring of the file data, and receives the file data by the communication unit.

Further, when transferring data between the transmitter communication device and the recipient communication device, the data can be transferred using a communication connection different from a communication connection used for transmitting a composed video.

According to the present invention, when the user at the recipient communication device designates an image of file data composed with a video, position information of the designated image is transmitted to the transmitter communication device, and corresponding file data is transmitted to the recipient communication device. As described above, transferring of data is carried out only when the recipient communication device carries out a request. Therefore, file data can be transferred flexibly according to a request of a user. Since file data is transferred only when necessary, load of a network can be reduced.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a first preferred embodiment of the present invention.

FIG. 2 is a flowchart illustrating an example of a processing carried out by a transmitter communication device when transmitting a video according to the first preferred embodiment of the present invention.

FIG. 3 illustrates an example of a processing carried out by the transmitter communication device when transmitting a video according to the first preferred embodiment of the present invention.

FIG. 4 illustrates an example of management information.

FIG. 5 is a flowchart illustrating an example of a processing carried out by a recipient communication device when receiving a video according to the first preferred embodiment of the present invention.

FIG. 6 illustrates an example of a video displayed at the recipient communication device according to the first preferred embodiment of the present invention.

FIG. 7 is a flowchart illustrating an example of processing carried out by the transmitter communication device when receiving a file acquiring request command according to the first preferred embodiment of the present invention.

FIG. 8 is a flowchart illustrating an example of a processing carried out by the recipient communication device after transmitting a file acquiring request command according to the first preferred embodiment of the present invention.

FIG. 9 schematically illustrates communication carried out between the transmitter communication device and the recipient communication device according to the first preferred embodiment of the present invention.

FIG. 10 is a block diagram illustrating a second preferred embodiment of the present invention.

FIG. 11 is a flowchart illustrating an example of a processing carried out by a transmitter communication device when transmitting a video according to the second preferred embodiment of the present invention.

FIG. 12 is a flowchart illustrating an example of a processing carried out by a recipient communication device when receiving a video according to the second preferred embodiment of the present invention.

FIG. 13 is a flowchart illustrating an example of processing carried out by the transmitter communication device when receiving a file acquiring request command according to the second preferred embodiment of the present invention.

FIG. 14 schematically illustrates communication carried out between the transmitter communication device and the recipient communication device according to the second preferred embodiment of the present invention.

### DETAILED DESCRIPTION OF PREFERRED EMBODIMENTS

### First Preferred Embodiment

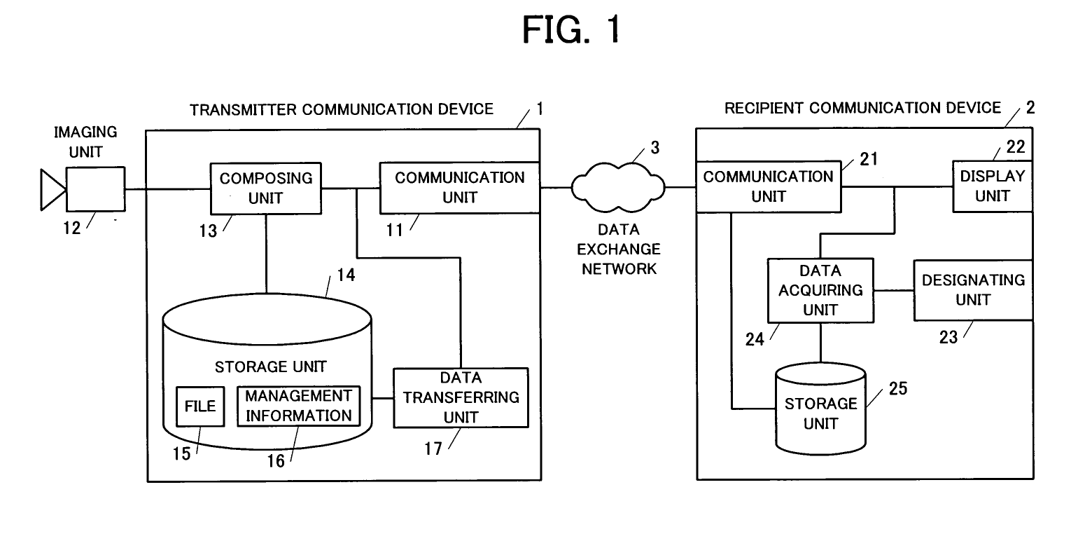

FIG. 1 is a block diagram illustrating a first preferred embodiment of the present invention. In the drawing, reference numeral 1 denotes a transmitter communication device, 2 denotes a recipient communication device, 3 denotes a data exchange network, 11 denotes a communication unit, 12 denotes an imaging unit, 13 denotes a composing unit, 14 denotes a storage unit, 15 denotes file data, 16 denotes management information, 17 denotes a data transferring unit, 21 denotes a communication unit, 22 denotes a display unit, 23 denotes a designating unit, 24 denotes a data acquiring unit, and 25 denotes a storage unit. In an example illustrated in FIG. 1, the transmitter communication device 1 and the recipient communication device 2 are connected capable of carrying out communication via the data exchange network 3. Further, other various communication devices may be connected to the data exchange network 3. For example, a plurality of transmitter communication devices 1 may be provided, or a plurality of recipient communication devices 2 may be provided.

In the example illustrated in FIG. 1, the transmitter communication device 1 includes the communication unit 11, the imaging unit 12, the composing unit 13, the storage unit 14, and the data transferring unit 17 or the like. The communication unit 11 carries out communication with the recipient communication device 2 or the like through the data exchange network 3. Further, as to be described later, transmission of a composed video and transferring of data are carried out from the communication unit 11. However, different communication connections are used for transmission of a composed video and for transferring of data.

The imaging unit 12 videos a video to be transmitted. Further, the video to be transmitted is not required to be videoed by the imaging unit 12, and previously prepared video data may be used.

The composing unit 13 creates a composed video by composing an image of relating data and a video to be transmitted. The created composed video is transmitted from the communication unit 11. Data is stored in the storage unit 14 as the file 15. When creating the composed video, a position of an image of data in the composed video is associated with the composed data or the file 15, and stored in the storage unit 14 as the management information 16.

The storage unit 14 stores various pieces of information necessary to be stored in the transmitter communication device 1. In particular, the storage unit 14 stores the file 15 storing data to be composed with a video, and the management information 16 in which a position in the composed image of the image of the data composed with the video by the composing unit 13 is associated with the data or the file 15.

When the communication unit 11 receives a data transferring request from the recipient communication device 2, the data transferring unit 17 specifies the data or the file 15 associated in the management information 16 stored in the storage unit 14 according to received position information. Then, the specified data or data included in the specified file 15 is transmitted from the communication unit 11 to the recipient communication device 2.

In the example illustrated in FIG. 1, the recipient communication device 2 includes the communication unit 21, the display unit 22, the designating unit 23, the data acquiring unit 24, and the storage unit 25 or the like. The communication unit 21 carries out communication with the transmitter communication device 1 or the like through the data exchange network 3. For example, the recipient communication device 2 can receive a composed video from the transmitter communication device 1. Alternatively, the recipient communication device 2 can transmit a data transferring request and receive data. Each of such communications can be carried out by using different communication connections.

The display unit 22 displays various pieces of information to be presented to a user at the recipient communication device 2. For example, a composed image, which has been formed by composing an image of data and a video and received by the communication unit 21, may be displayed.

The designating unit 23 accepts various designations made by the user at the recipient communication device 2. As a designation, when the user designates one point or a range in the composed image displayed on the display unit 22, the designating unit 23 accepts the designated position.

The data acquiring unit 24 requests the transmitter communication device 1 via the communication unit 21 to transfer data including position information of the position in the composed image designated by the user from the designating unit 23 and also a frame number or the like that specifies the composed image being displayed on the display unit 22. Then, corresponding data is received by the communication unit 21.

The storage unit 25 stores various pieces of information necessary to be stored in the recipient communication device 2. For example, the storage unit 25 stores a received composed video according to necessity. Alternatively, when receiving the data requested by the data acquiring unit 24, the storage unit 25 stores the received data.

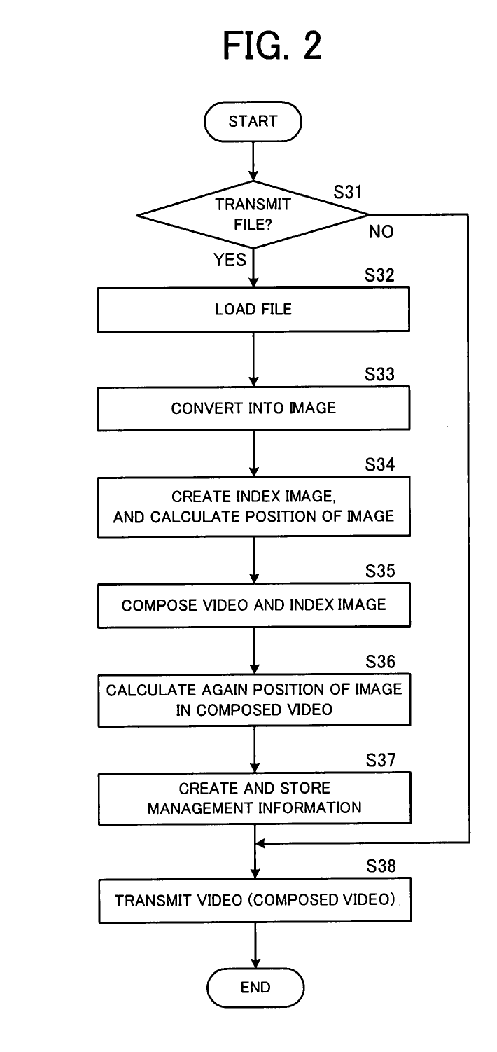

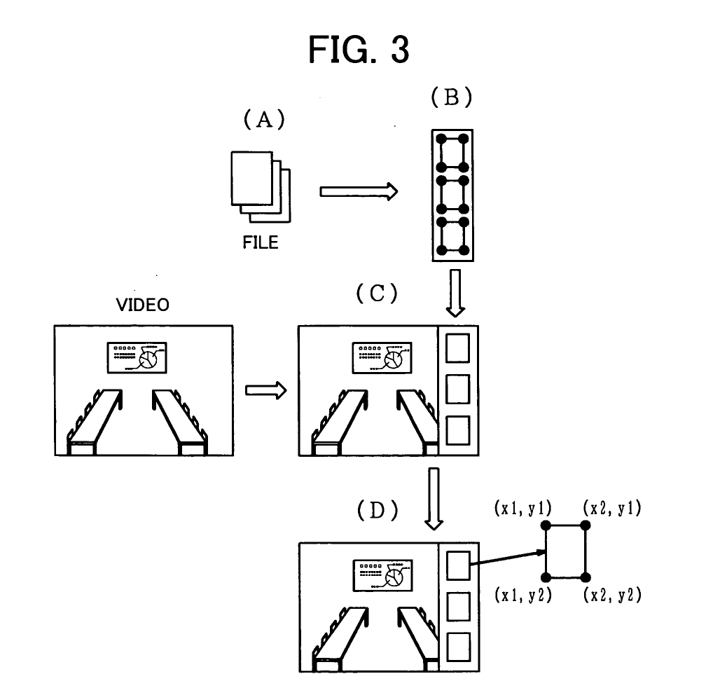

Next, a description will be made of an example of an operation carried out according to the first preferred embodiment of the present invention. FIG. 2 is a flowchart illustrating an example of a processing carried out by the transmitter communication device 1 when transmitting a video according to the first preferred embodiment of the present invention. FIG. 3 illustrates an example of a processing carried out at transmission of a video. First, at step S31, a determination is carried out as to a presence or an absence of the file 15 (file data) to be transmitted separately from a video. When transferring of data is not necessary, the process proceeds onto step S38 and a video is transmitted from the communication unit 11 to the recipient communication device 2.

In case of a presence of the file 15 to be transmitted, the file 15 is loaded at step S32, and contents of the file 15 are converted into an image at step S33. FIG. 3(A) illustrates an example in which the file 15 includes data of a plurality of pages. When converting the contents of the file 15 into an image at step S33, an image can be formed for each of the pages, or only a representing page (for example, a first page) of the file 15 may be converted into an image. Such conversions may be appropriately switched.

At step S34, an index image is created for collectively composing one image or a plurality of images created at step S33 with the video (FIG. 3(B)). In this case, a position of each of the images included in the index image is calculated. For example, in FIG. 3(B), positions represented by black circles are calculated.

At step S35, the composing unit 13 composes the video to be transmitted and the index image created at step S34 (FIG. 3(C)). Accordingly, the video and the contents of the file 15 are composed. When composing, since a position of the index image included in the video can be learnt, the position of each image calculated at step S34 is calculated again at step S36 into a position in the video according to the position of the index image in the video. FIG. 3(D) illustrates an example in which a position in the video is calculated again for one image composed in the video, and as a result, four corner positions are (x1, y1), (x2, y2), (x1, y2), and (x2, y2)

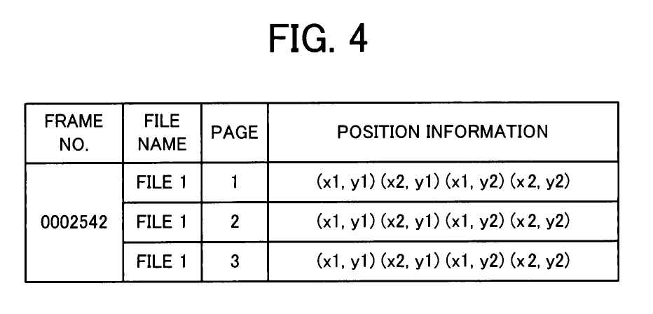

At step S37, the management information 16 is created from the position of the image calculated again at step S36, and stored in the storage unit 14. FIG. 4 illustrates an example of management information. In an example of the management information 16 illustrated in FIG. 4, a frame number in the video to which the index image has been composed is associated with a file name and a page number of a file, which is an original of the image existing in the index image, and in addition, a position of the image calculated again at step S35. The video generally includes a plurality of frame images which are arranged chronologically. Even when an index image including different images is composed in one video while changing time for each of the images, each of the images can be distinguished by a frame number specifying each of the frame images. Accordingly, each of the images can be distinguished. A video may be specified by other methods. For example, time may be associated from a head of the video instead of using a frame number. Alternatively, when composing only the same index image in one video, information such as the frame number is unnecessary. When creating images in an index image by unit of files instead of by unit of pages, a column for page is also unnecessary. Moreover, other various pieces of information may be associated.

At step S38, the composed video, which has been formed by composing the video and the index image at step S35, is transmitted from the communication unit 11 to the recipient communication device 2. In a manner described above, the image of the contents of the file 15 can be composed with the video and transmitted to the recipient communication device 2.

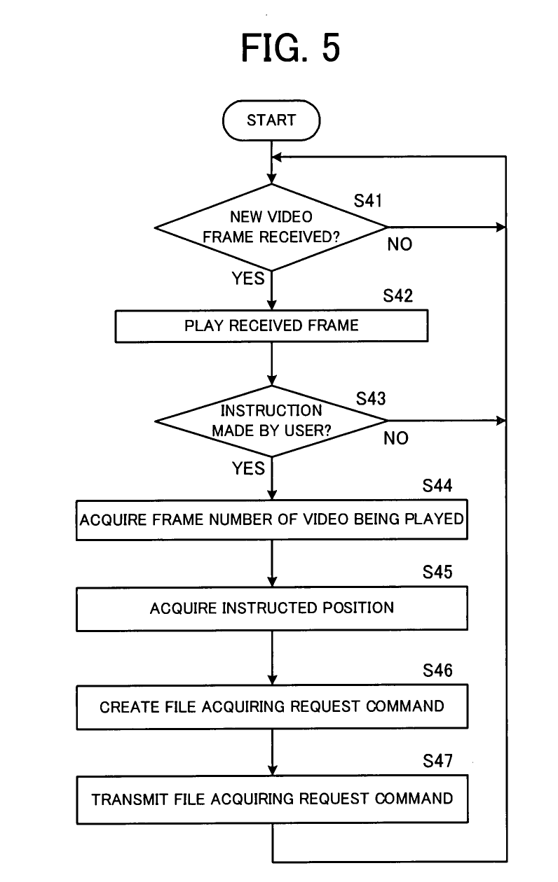

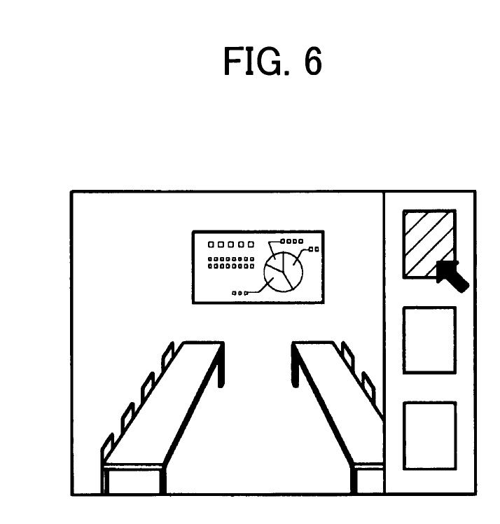

FIG. 5 is a flowchart illustrating an example of a processing carried out by the recipient communication device 2 when receiving a video according to a first preferred embodiment of the present invention. FIG. 6 illustrates an example of a displayed video. At step S41, the recipient communication device 2 waits until receiving a new frame of a video by the communication unit 21. Then, at step S42, the received new frame is displayed on the display unit 22, and the video is played. For example, the display unit 22 displays a video in which index images are composed as illustrated in FIG. 6.

When the user of the recipient communication device 2 refers to the played video, the user also refers to the images displayed as the index image. When the user needs information displayed as an image, the user designates an image by the designating unit 23 and requests to acquire data corresponding to the designated image. In FIG. 6, an upper image is designated as illustrated by an arrow.

At step S43, a determination is carried out as to whether or not the user has carried out an instruction to the designating unit 23. When the user has not carried out an instruction, the process returns to step S41 and the video continues to be played. When the user carries out an instruction, at step S44, the data acquiring unit 24 acquires a frame number of the video currently being displayed. Then, at step S45, the data acquiring unit 24 acquires a position in the video designated by the user. At step S46, a file acquiring request command is created from the frame number and the position designated by the user. At step S47, the file acquiring request command is transmitted from the communication unit 21 to the transmitter communication device 1. Then, the process returns to step S41. The video continues to be played, and a processing for responding to the transmitted file acquiring request command is carried out simultaneously.

Further, when a frame number is not used, for example, when a change cannot be made to the index image composed in the received video, the process of step S44 is unnecessary. In addition, at step S45, a file acquiring request command can be created according to the position designated by the user.

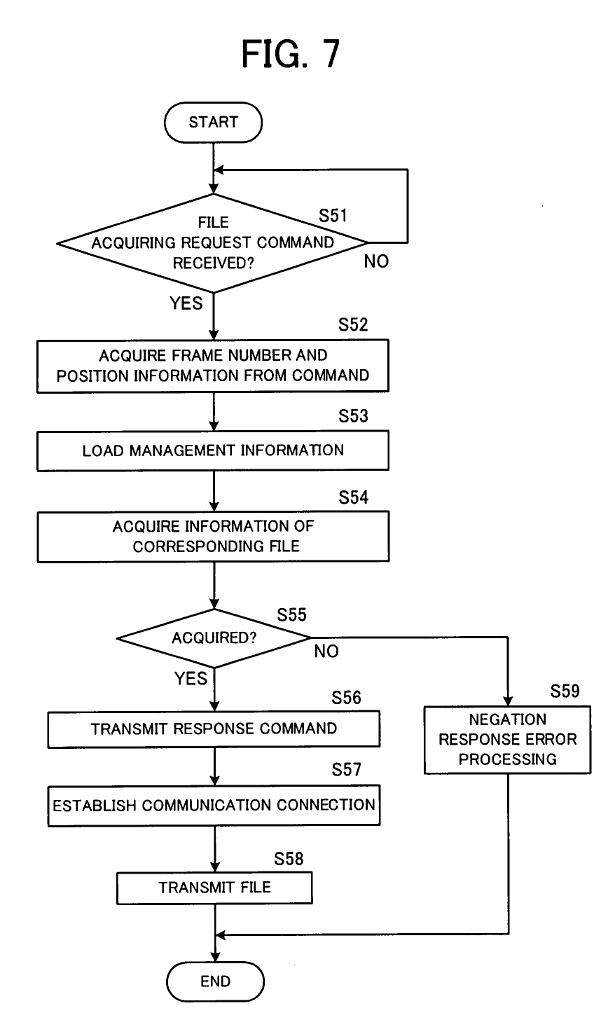

FIG. 7 is a flowchart illustrating an example of a processing carried by the transmitter communication device 1 when receiving a file acquiring request command according to the first preferred embodiment of the present invention. At step S51, a determination is carried out as to whether or not a file acquiring request command has been received from the recipient communication device 2. The transmitter communication device 1 waits until receiving a file acquiring request command.

When receiving a file acquiring request command, at step S52, a frame number and information of the position designated by the user are acquired from the received file acquiring request command. Further, when a frame number is not used, the frame number is not required to be acquired.

At step S53, the management information 16 is loaded from the storage unit 14. At step S54, information of a corresponding file (in the example of the management information illustrated in FIG. 4, a file name and information of a page) is acquired from the frame number and the position information acquired at step S52.

At step S55, a determination is carried out as to information of the corresponding file has been acquired. In case of an absence of information of the corresponding file, at step S59, an error processing is carried out. For example, a response command for carrying out a negation response is transmitted from the communication unit 11 to the recipient communication device 2. Then, the processing carried out when receiving the file acquiring request command is ended.

When information of the corresponding file is acquired, at step S56, a response command for carrying out an affirmative response is transmitted from the communication unit 11 to the recipient communication device 2. At step S57, a new communication connection is established for transferring a file. At step S58, a corresponding file 15 (a corresponding page in the file 15) stored in the storage unit 14 is transferred to the recipient communication device 2. Then, the processing carried out when receiving the file acquiring request command is ended.

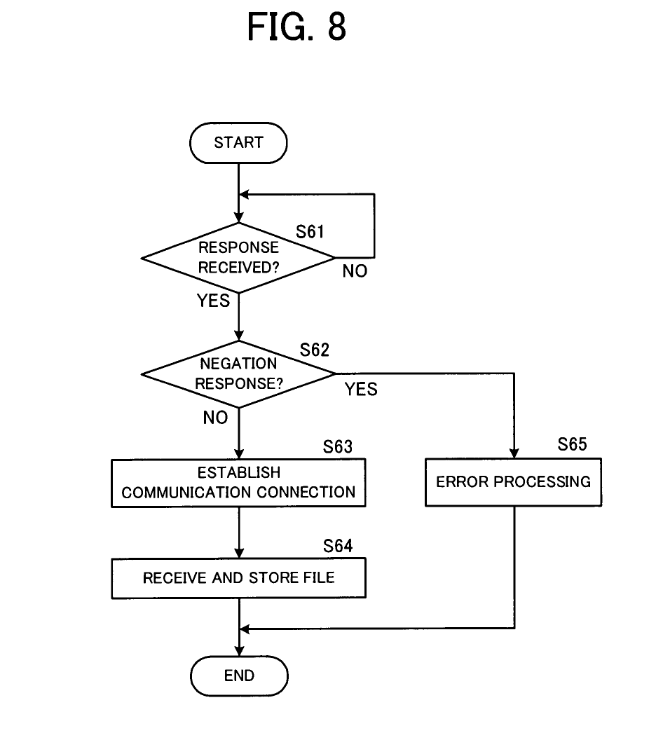

FIG. 8 is a flowchart illustrating an example of a processing carried out by the recipient communication device 2 after transmitting the file acquiring request command according to the first preferred embodiment of the present invention. After transmitting the file acquiring request command at step S47 of FIG. 4, at step S61, the recipient communication device 2 waits for a response command from the transmitter communication device 1. When receiving a response command from the transmitter communication device 1, at step S62, a determination is carried out as to whether the received response command is an affirmative command or a negation command. When the received response command is a negation response, at step S65, an error processing is carried out. For example, the display unit 22 displays a message indicating a fact that a corresponding file does not exist. Then, the processing is ended.

When the received response command is an affirmative response, at step S63, anew communication connection is established for accepting transferring of a file. Then, at step S64, the recipient communication device 2 accepts transferring of the file (or a page of the file). The received file (or the page) is stored in the storage unit 25, and the processing is ended. A user separately accesses the file or the page of the file stored in the storage unit 25 to confirm the contents of the file or the page of the file stored in the storage unit 25. Alternatively, the display unit 22 may automatically display the received file or the page of the file.

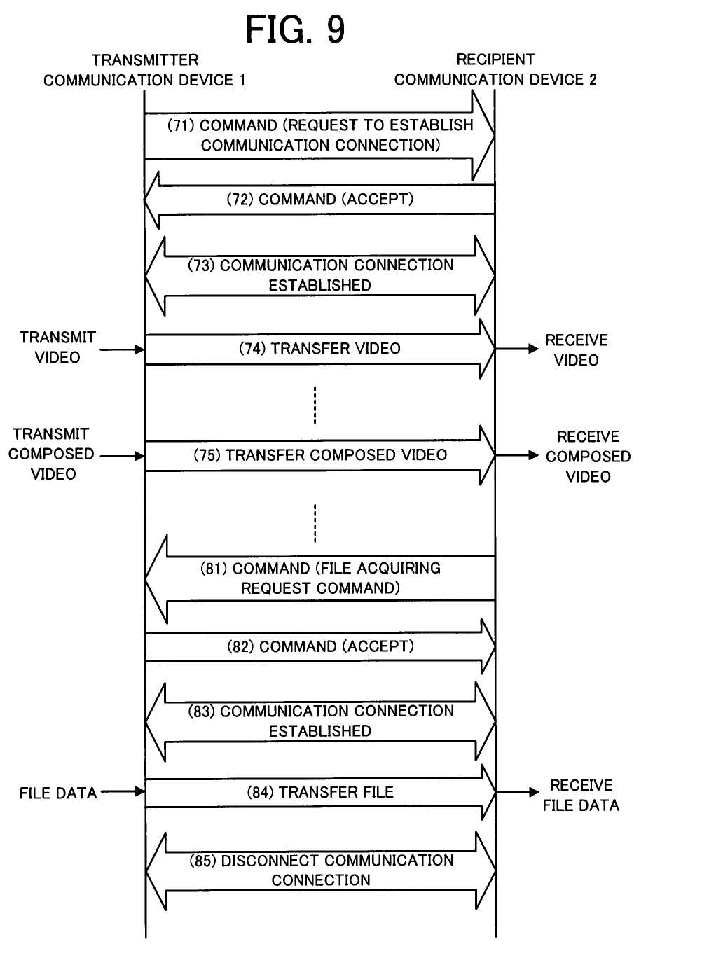

FIG. 9 schematically illustrates communication carried out between the transmitter communication device 1 and the recipient communication device 2 according to the first preferred embodiment of the present invention. An example of the operation carried out by the transmitter communication device 1 has been described with reference to FIG. 2 and FIG. 7. An example of the operation carried out by the recipient communication device 2 has been described with reference to FIG. 5 and FIG. 8. Next, relation of the above-described operations will be described.

In an example illustrated in FIG. 9, at (71), a command for requesting to start a communication connection (for example, an INVITE command) is transmitted from the transmitter communication device 1 to the recipient communication device 2. At (72), the recipient communication device 2 returns a command indicating that the command has been accepted (for example, an OK command) to the transmitter communication device 2. Then, as illustrated at (73), a communication connection is started. Moreover, the recipient communication device 2 may request the transmitter communication device 1 to start a communication connection. In the example illustrated in FIG. 9, a Real-time Transfer Protocol (RTP) connection for a video is established as a media session.

The transmitter communication device 1 transfers a video by using the started communication connection. In the example illustrated in FIG. 9, at (74), only a video is transferred at a start of transferring of the video. Then, at (75), the video and the index image are composed and transferred. As described above, the index image may be composed with the video according to necessity. An index image to be composed may be changed at any point of time. Even when a video is composed with an index image as described above, only the contents of the video to be transferred changes, and the communication can be carried out through the same communication connection. The recipient communication device 2, which has received the video, displays the video on the display unit 22 according to the example of the operation illustrated in FIG. 5 or further stores the video in the storage unit 25.

When the user designates a position in the index image in the video being displayed, at (81), the recipient communication device 2 transmits the designated position and/or a frame number or the like as a file acquiring request command (for example, an INVITE command) to the transmitter communication device 1. Suppose that when the video composed with the index image as illustrated in FIG. 6 is displayed, on the display of a file or a page of the file, a user designates transferring of the file or the page of the file. According to the designation made by the user, the processing of step S43 and onwards of FIG. 5 are executed. The file acquiring request command illustrated at (81) is transmitted from the recipient communication device 2 to the transmitter communication device 1.

When receiving the file acquiring request command, the transmitter communication device 1 carries out a processing illustrated in FIG. 7. The transmitter communication device 1 extracts position information and/or a frame number or the like from the received file acquiring request command, and determines as to a presence or an absence of information of a corresponding file or a page from the management information 16. In case of a presence of information of a corresponding file or a page, the transmitter communication device 1 returns a command indicating that the file acquiring request command has been accepted (for example, an OK command) to the recipient communication device 2 at (82). At (83), a new communication connection is established. The newly established communication connection is provided separately from the communication connection established at (73) for transferring a video. Therefore, the communication of (81) and onwards can be carried out simultaneously with transferring of a video using the communication connection established at (73). In the first preferred embodiment, a Transmission Control Protocol (TCP) connection is established as a media session for transferring a file. Moreover, a File Transfer Protocol (FTP) or a Hyper Text Transfer Protocol (HTTP) connection, which is higher protocol, may be established.

In case of an absence of information of a corresponding file or a page, the transmitter communication device 1 transmits an error command to the recipient communication device 2, and the processing for the received file acquiring request command is ended. The recipient communication device 2 also receives an error command and carries out an error processing according to an example of the operation illustrated in FIG. 8.

When a new communication connection is established, by using the newly established communication connection, at (84), information of the file or the page corresponding to the position information and/or the frame number designated in the file acquiring request command is transferred. The recipient communication device 2 receives information of the file or the page and stores the received information in the storage unit 25 or the like according to the example of the operation illustrated in FIG. 8.

When the transferring is completed, the communication connection used for transferring the information of the file or the page is disconnected (85). The communication connection can be disconnected by a BYE command or the like. Further, since the communication connection used for transferring the video is maintained, playing of the displayed video does not end by the disconnection of the communication connection at (85).

Further, when the user has designated a plurality of files or pages in the video in which the index image is composed, position information of the designated files or pages can be collectively transmitted as a file acquiring request command from the recipient communication device 2 to the transmitter communication device 1. In this case, the transmitter communication device 1 establishes a corresponding communication connection for each of the designated files or pages, and information of the files or the pages can be transferred simultaneously. Moreover, one communication connection for transferring data may be established, and the established communication connection may be used for sequentially transferring the information of the file or the page.

As described above, the transmitter communication device 1 composes the index image and the video and transmits the video composed with the index image according to necessity. While looking at the received video, the recipient communication device 2 instructs to acquire data according to necessity. Accordingly, the recipient communication device 2 can receive corresponding data (a file or a page of a file). As described above, the data of the file or the page in the file is transferred only when it is necessary to transfer the data. Therefore, load of the data exchange network 3 can be reduced. Since only data which has been determined by the user to be necessary is transferred to the recipient communication device 2, accumulation of data resulting from transferring of unnecessary data can be prevented. As a result, management of data can be carried out easily. Furthermore, the transmitter communication device 1 can present necessary data to the recipient communication device 2 when necessary.

For example, when the transmitter communication device 1 is distributing a video to a plurality of recipient communication devices 2, the transmitter communication device 1 may select and distribute a video composed with an index image and a video without an index image according to a transmission destination. Even when distributing a video after composing an index image to the video, an index image to be composed with the video may be selected according to the transmission destination, and then the index image may be composed with the video. Accordingly, the transmitter communication device 1 can control whether or not to permit transferring of data or to permit which data to be transferred according to a distribution destination. As described above, when distributing a video to a plurality of recipient communication devices 2, a different communication connection is established with each of the recipient communication devices 2 and the communication is carried out. When transferring data, as described above, a different communication connection is established with the recipient communication device 2 of the transfer destination.

### Second Preferred Embodiment

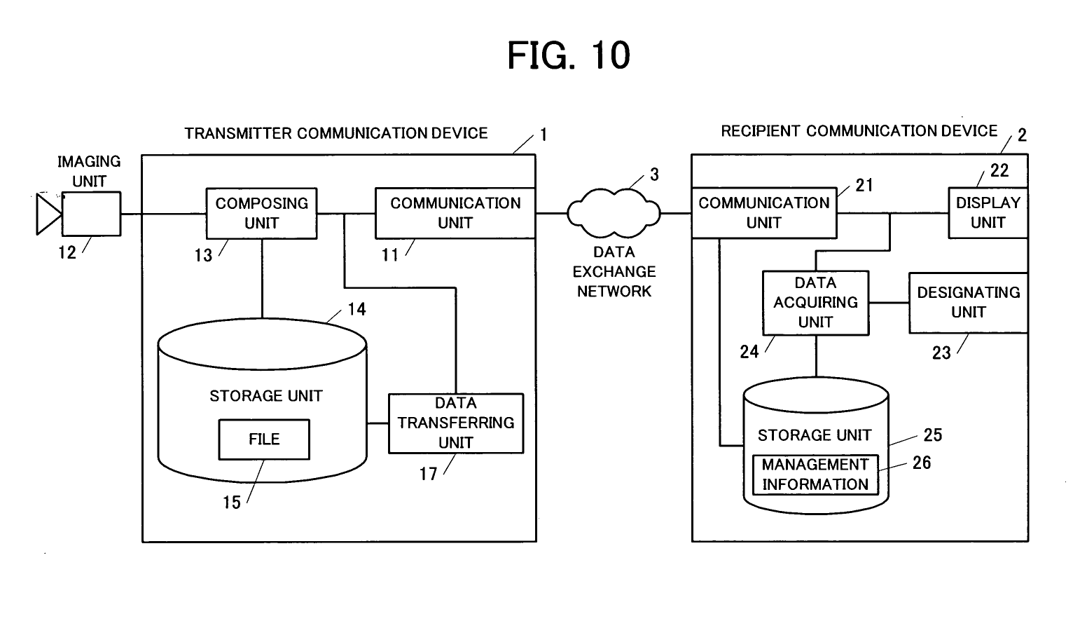

FIG. 10 is a block diagram illustrating a second preferred embodiment of the present invention. In FIG. 10, like reference numerals are assigned to like constituent elements described with reference to FIG. 1, and a description will be omitted. Reference numeral 26 denotes management information. In the above-described first preferred embodiment, the transmitter communication device 1 stores management information in which a position of an image of data in the composed video is associated with the composed data or the file 15. In the second preferred embodiment, the management information is transmitted to the recipient communication device 2, and the recipient communication device 2 stores the received management information in the storage unit 25 as the management information 26.

The composing unit 13 of the transmitter communication device 1 creates a composed video by composing an image of relating data to a video to be transmitted, and transmits the created composed video from the communication unit 11. When creating a composed video, the composing unit 13 creates management information in which a position of the image of the data in the composed video is associated with the composed data or the file 15. The created management information is also transmitted from the communication unit 11 to the recipient communication device 2. A method for transferring the management information can be any method. Further, the management information can be stored arbitrarily in the storage unit 14.

When the communication unit 11 receives a data transferring request from the recipient communication device 2, the data transferring unit 17 transmits corresponding data stored in the storage unit 14 from the communication unit 11 to the recipient communication unit 2 according to information for specifying the received data.

When receiving the composed video from the transmitter communication device 1, the communication unit 21 of the recipient communication device 2 receives the management information 26 of the composed video from the transmitter communication device 1, and stores the received management information 26 in the storage unit 25.

According to the position information of the position in the composed image designated by the user from the designating unit 23, the data acquiring unit 24 refers to the management information 26 stored in the storage unit 25, and acquires information of corresponding data. Then, the data acquiring unit 24 transmits the acquired information of the data from the communication unit 21 to the transmitter communication device 1 to request transferring of data. Then, data transmitted from the transmitter communication device 1 in response to the request is received by the communication unit 21.

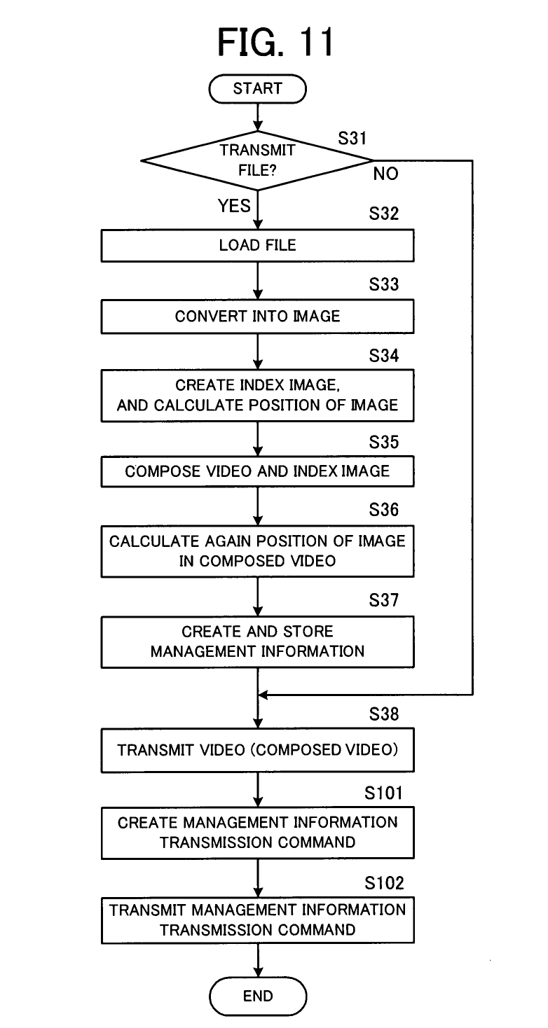

Next, a description will be made of an example of an operation according to the second preferred embodiment of the present invention. FIG. 11 is a flowchart illustrating an example of a processing carried out by the transmitter communication device 1 when transmitting a video according to the second preferred embodiment of the present invention. Further, like reference numerals are assigned to steps in which the same processing is carried out as in FIG. 2. The processing from steps S31 through S38 is substantially the same as the above-described first preferred embodiment. Further, the management information created at step S37 may be stored in the storage unit 14 according to necessity. As described above with reference to FIG. 4, the management information may include various pieces of information including at least position information and information for specifying data of a file or a page or the like.

At step S101, a command for transferring the management information created at step S37 is created. At step S102, the created command is transmitted from the communication unit 11 to the recipient communication device 2. As described above, an image of data such as contents of the file 15 can be composed with a video, and the video composed with the image can be transmitted to the recipient communication device 2. In addition, management information in which a position of the image in the video and the data such as contents of the file 15 are associated can be transmitted to the recipient communication device 2.

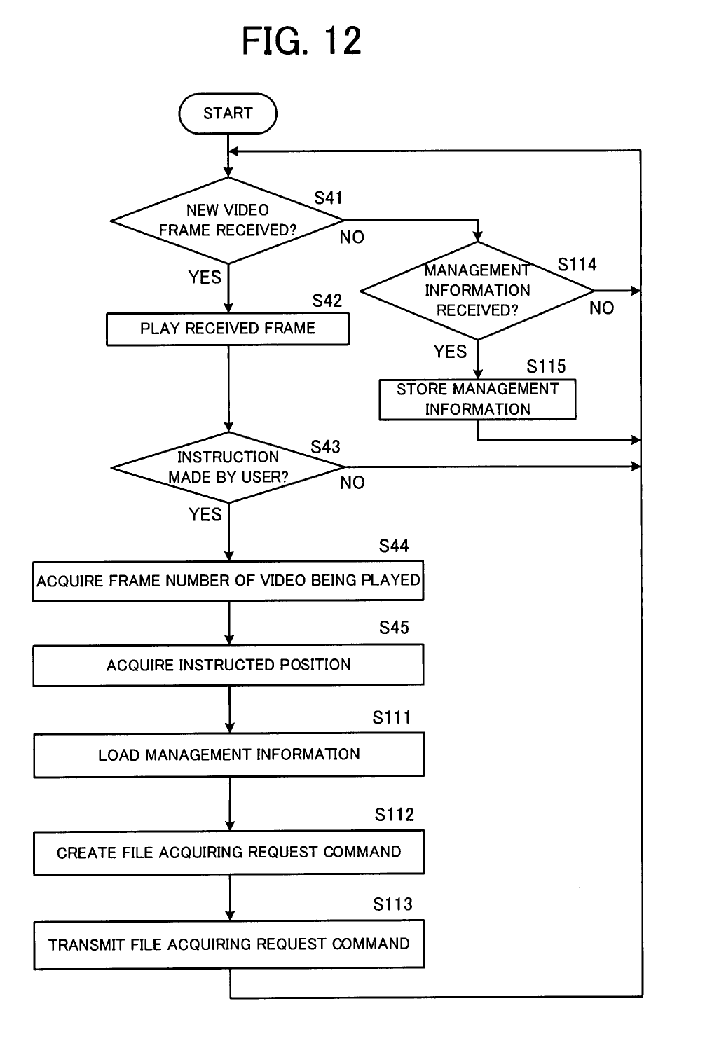

FIG. 12 is a flowchart illustrating an example of a processing carried out by the recipient communication device 2 when receiving a video according to the second preferred embodiment of the present invention. Further, like reference numerals are assigned to steps in which the same processing is carried out as in FIG. 5. The processing from steps S41 through 45 is substantially the same as the above-described first preferred embodiment. When a determination is made at step S41 that a new frame of the video has not been received, a determination is further carried out at step S114 as to whether or not the management information 26 has been received. The recipient communication device 2 waits until receiving a new frame of the video or the management information 26. When a determination is made at step S114 that the management information 26 has been received, at step S115, the received management information 26 is stored in the storage unit 25.

When a determination is made at step S41 that a new frame has been received, in the same manner as in the first preferred embodiment, the received frame is displayed on the display unit 22. When the user who has referenced the display designates a position in the video, a frame number of the video being played is acquired at step S44. At step S45, the designated position is acquired. In the second preferred embodiment, at step S111, the management information 26 stored in the storage unit 25 is loaded. Then, information of data corresponding to the frame number and the position acquired at steps S43 and S44, for example, a file name and a page number or the like, is acquired from the loaded management information 26. At step S112, a command for requesting transferring of data (hereinafter referred to as a “file acquiring request command”) is created at step S112 according to the acquired information of the data. At step S113, the created file acquiring request command is transmitted from the communication unit 21 to the transmitter communication device 1. Further, when a frame number is not being used, or when new management information is transmitted at an update of an index image composed in a video, the frame number is not required to be acquired if the latest management information is used.

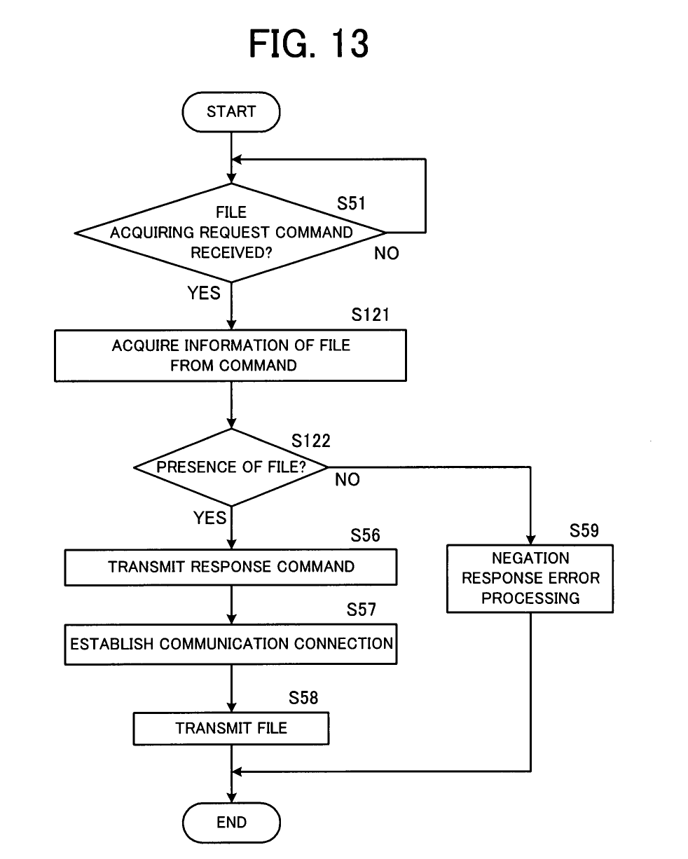

FIG. 13 is a flowchart illustrating an example of a processing carried out by the transmitter communication device 1 when receiving a file acquiring request command according to the second preferred embodiment of the present invention. Further, like reference numerals are assigned to steps in which the same processing is carried out as in FIG. 7, and a redundant description will be omitted. When a determination is made at step S51 that a file acquiring request command has been received from the recipient communication device 2, at step S121, information of the data, for example, a file name and a page number or the like, is acquired from the received file acquiring request command. At step S122, a determination is carried out as to a presence or an absence of requested data. In case of the absence of such data, at step S59, an error processing is carried out. For example, a response command for carrying out a negation response is transmitted from the communication unit 11 to the recipient communication device 2. Then, the processing carried out when receiving the file acquiring request command is ended.

When data of the requested file 15 or a page of the file 15 is acquired, in the same manner as described above in the first preferred embodiment, at step S56, a response command for carrying out an affirmative response is transmitted from the communication unit 11 to the recipient communication device 2. At step S57, a new communication connection is established. By using the newly established communication connection, at step S58, the requested data is transferred to the recipient communication device 2. Then, the processing carried out when receiving the file acquiring request command is ended.

Further, a processing carried out by the recipient communication device 2 after transmitting the file acquiring request command in the second preferred embodiment is the same as the processing carried out with reference to FIG. 8 in the first preferred embodiment. Thus, a detailed description will be omitted. Briefly, when a response command from the transmitter communication device 1 is received, a new communication connection is established, and data is received by using the newly established communication connection.

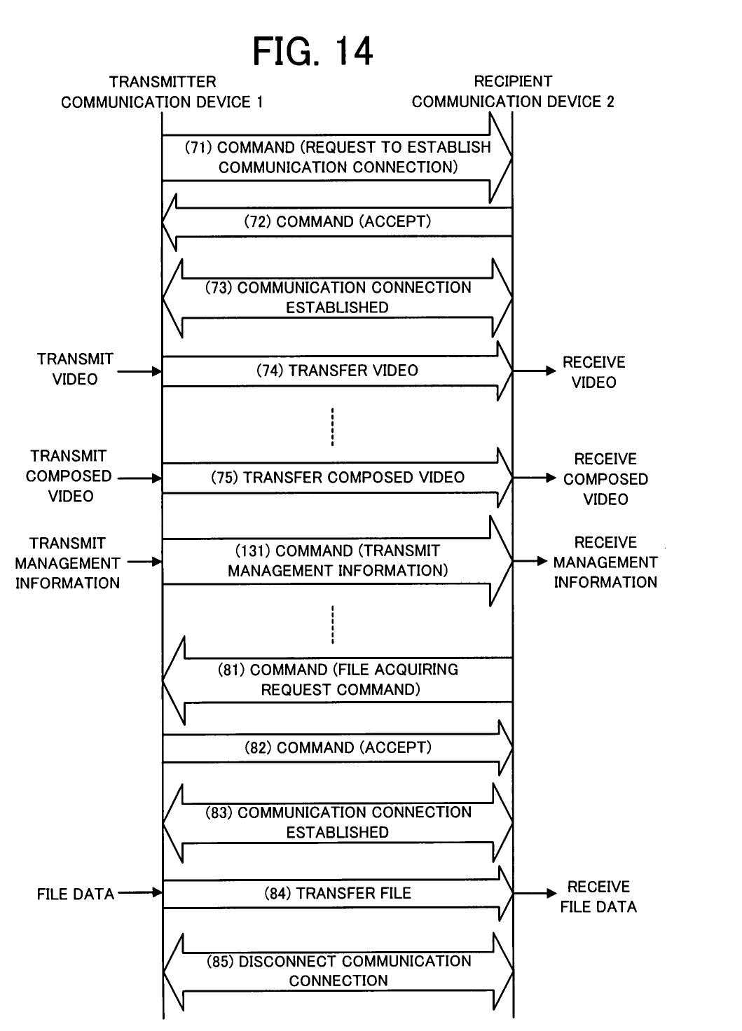

FIG. 14 schematically illustrates communication carried out between the transmitter communication device 1 and the recipient communication device 2 according to the second preferred embodiment of the present invention. An example of the operation carried out by the transmitter communication device 1 according to the second preferred embodiment has been described with reference to FIG. 11 and FIG. 13. An example of an operation carried out by the recipient communication device 2 according to the second preferred embodiment has been described with reference to FIG. 12 (and FIG. 8). Next, a relation of the above-described operations will be described. Communication carried out from (71) to (75), i.e. communication carried out from start of communication until transferring a video (composed video), is the same as the communication carried out in the first preferred embodiment.

In the second preferred embodiment, when a composed video composed with an index image is transferred at (75), management information in which the position of the image of the data and the information of the data in the composed image are associated is transmitted at (131) from the transmitter communication device 1 to the recipient communication device 2. The management information can be transmitted by using a MESSAGE command or the like. Alternatively, a separate communication connection can be established, and the management information can be transmitted through such a communication connection. At step S115 of FIG. 12, the recipient communication device 2 stores the received management information in the storage unit 25.

When the user makes a designation in the displayed video, the recipient communication device 2 acquires information of data from the management information by the processing of step S44 of FIG. 12 and onwards. At (81), the information of the data is transmitted as the file acquiring request command (for example, an INVITE command) to the transmitter communication device 1.

The transmitter communication device 1 carries out a processing illustrated in FIG. 13 with respect to the received file acquiring request command. The transmitter communication device 1 acquires information of data from the received file acquiring request command, and searches as to a presence or an absence of data of a corresponding file or a page or the like. In case of the presence of the data, at (82), the transmitter communication device 1 returns a command indicating that the file acquiring request command (for example, an OK command) has been received to the recipient communication device 2. At (83), a new communication connection is established. At (84), requested data is transferred to the recipient communication device 2 by using the newly established communication connection. The new communication connection is a TCP connection established as a media session for transferring a file. The new communication connection may be the FTP or the HTTP connection, which is a higher protocol. The recipient communication device 2 receives information of the file or the page and stores the received information in the storage unit 25 or the like according to the example of the operation illustrated in FIG. 8.

When transferring is completed, at (85), the communication connection used for transferring the data is disconnected. The communication connection can be disconnected by a BYE command or the like. Further, since the communication connection used for transferring the video is still maintained, playing of the displayed video is not ended by the disconnection of the communication connection.

As described above, also in the second preferred embodiment, in the same manner as in the first preferred embodiment, the transmitter communication device 1 composes the index image and the video and transmits the composed video according to necessity. The recipient communication device 2 can instruct acquiring of data according to necessity while looking at the received video, and receive corresponding data (a file or a page of a file). Therefore, advantages of the first preferred embodiment can also be obtained in the second preferred embodiment. Various changes and modifications may be made to the second preferred embodiment in the same manner as in the first preferred embodiment.

In the above-described first and second preferred embodiments, different communication connections are used for a video (composed video) and data. The communication connections may be realized by using the TCP, the User Datagram Protocol (UDP) or even higher communication protocols (for example, the HTTP, the FTP, or the RTP).

A system according to the above-described first and second preferred embodiments and modifications thereof or the like may be applied to, for example, a teleconference system. For example, a video of a state of a conference or a specific person, a speaker or the like can be distributed to each location to proceed the conference. During the course of the conference, when a reference becomes necessary or when an appropriate time for providing a reference is reached, a composed image, which has been formed by composing an image of the reference and the video, is distributed. At this time, in case of the second preferred embodiment, the management information is also transmitted. Moreover, the composed image is not necessarily required to be distributed to all locations. An image to be composed may be differed for each location, and a reference to be distributed may be differed for each location. At each location where the video is being referenced, an image of a reference displayed in the video may be referenced. When necessary, by designating the image, a corresponding reference may be received.

As described above, all references are not required to be transmitted in advance or an image of the references is not required to be made and transmitted during the conference as in a conventional system. A transmitter can present an existence of a reference to a necessary location when necessary, and each location can receive only a necessary reference.

The present invention can also be applied to various other purposes accompanying distribution of a video in addition to a teleconference system.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A communication device comprising:
a communication unit which carries out communication through a network;
a composing unit which transmits a composed image, which has been formed by composing an image of file data and a video, from the communication unit;
a storage unit which associates and stores a position of the image of the file data included in the composed video with the file data; and
a data transferring unit which specifies the file data from the storage unit according to a position received by the communication unit, and transmits the specified file data from the communication unit.

2. The communication device according to claim 1, wherein the communication unit transmits the file data by using a communication connection different from a communication connection used for transmitting the composed video.

3. The communication device according to claim 1, wherein the communication unit receives a plurality of positions, and the data transferring unit transmits a plurality of file data specified from the plurality of the positions from the communication unit.

4. A communication device comprising:
a communication unit which carries out communication through a network;
a composing unit which transmits a composed video, which has been formed by composing an image of file data and a video, from the communication unit; and
a data transmitting unit which transmits management information, in which a position of the image of the file data included in the composed video is associated with the file data, from the communication unit, and transmits the file data from the communication unit according to a data transferring request received by the communication unit.

5. The communication device according to claim 4, wherein the communication unit transmits the file data by using a communication connection different from a communication connection used for transmitting the composed video.

6. A communication device comprising:
a communication unit which carries out communication through a network;
a display unit which displays a composed image, which has been formed by composing an image of file data and a video received by the communication unit;
a designating unit which is operated by a user for designating a position in the displayed composed image; and
a data acquiring unit which transmits the position in the composed image designated by the user from the designating unit by the communication unit, and receives corresponding file data by the communication unit.

7. The communication device according to claim 6, wherein the communication unit receives the file data by using a communication connection different from a communication connection used for receiving the composed video.

8. The communication device according to claim 6, wherein the data acquiring unit transmits a plurality of positions to the communication unit, and a plurality of corresponding file data is received by the communication unit.

9. A communication device comprising:
a communication unit which carries out communication through a network;
a display unit which displays a composed image, which has been formed by composing an image of file data with a video received by the communication unit;
a designating unit which is operated by a user for designating a position of the image of the file data in the displayed composed image; and
a data acquiring unit which, according to management information in which the position of the image of the file data in the composed image received by the communication unit is associated with the file data, specifies file data from the position in the composed image designated by the user from the designating unit, transmits a request from the communication unit to a transmitter to request transferring of the file data, and receives the file data by the communication unit.

10. The communication device according to claim 9, wherein the communication unit receives the file data by using a communication connection different from a communication connection used for receiving the composed video.
